(19) United States
(12) Patent Application Publication
(10) Pub. No.: US 2026/0193890 A1
(43) Pub. Date: Jul. 9, 2026

(54) ILLUMINATING SANITARY ELEMENT FOR A SHOWER OR A BATHTUB

(71) Applicant: DERBELIGHT GMBH, Hamburg (DE)

(72) Inventor: Marvin RINAS, Hamburg (DE)

(21) Appl. No.: 18/881,564

(22) PCT Filed: Jul. 5, 2023
(86) PCT No.: PCT/EP2023/068575

§ 371 Date: Jan. 6, 2025

(30) Foreign Application Priority Data
Jul. 6, 2022 (DE) 10 2022 116 901.4

(51) Int. Cl. E04F 15/02; F21V 33/00

(52) U.S. Cl. CPC E04F 15/02172; E04F 15/02188; F21V 33/004; F21V 33/006

(57) ABSTRACT

A sanitary element includes a glass plate which is designed so as to transmit light at least partially, can be walked on and has a first surface formed on a first side of the glass plate and at least one illuminating element which is arranged on a side of the glass plate other than the first side. An anti-slip arrangement is arranged or formed on the first surface of the glass plate, which anti-slip arrangement, when the sanitary element is installed, is configured to prevent slipping when the glass plate is walked on by a user, in particular during showering or bathing, and wherein a decorative layer is arranged between the at least one illuminating element and the glass plate. Further, a sanitary system having at least one such sanitary element, a method for controlling this sanitary system, and a method of using of the sanitary system.

### FIELD

The invention relates to a sanitary element for a sanitary system, in particular for a shower, a bathtub, a sanitary basin or another sanitary fitting, comprising at least one illuminating element. Furthermore, the invention relates to a sanitary system having at least one such sanitary element. Furthermore, the invention relates to a method for controlling the sanitary system, and to a use of the sanitary system.

### BACKGROUND

Modern showers or bathtubs not only offer users ever better combinations of esthetics and functionality, but they are also a pleasant way to relax tired muscles after a long day at work or to start the day refreshed in the morning. To positively impact the shower experience, it is possible to equip showers or bathtubs with illuminants that can illuminate the interior of a shower cubicle or bathtub.

For example, illuminated tiles in general are known from the prior art, which are equipped with one or more illuminants for effect illumination on surfaces such as walls or ceilings. Tiles, which are used in particular as wall coverings or floor coverings, are thin, plate-shaped elements made of ceramic, natural stone, glass or cement. They can include mineral additives that change colors, light transmittance and other properties. The tile can substantially be formed from a transparent material or can be designed so as to be at least partially transparent for light waves in the spectral range visible to the human eye. By irradiating such tiles with the illuminants, the light rays can be scattered depending on the material properties of the tile plate, for illumination or for implementation of optical effects, for example. Such an illuminated tile is disclosed in DE 10 2005 002 783 A1, for example. The tile described there has a tile plate with a bottom, wherein at least one illuminant is provided, the light of which is directed substantially at the bottom of the tile plate.

The disadvantages of the prior art are, however, that the tiles are designed only for walls and ceilings in normal interior rooms of buildings and therefore do not meet the watertightness requirements of a wet cell. In particular, the prior art does not meet the requirements of a floor tile of a shower or a bathtub. In addition, the illuminating models are technically limited to only illuminating certain colors and shapes. Furthermore, the prior art lacks the possibility of easy installation. Accordingly, there is a need to overcome the disadvantages of the prior art and to provide an improved showering or bathing experience.

### SUMMARY

Therefore, the object of the invention is to overcome the disadvantage of the prior art and to provide an easy-to-install sanitary element, which, on the one hand, has a positive impact on the bathing or showering experience for a bathing or showering user and, on the other hand, reduces the risk of slipping during use, especially when walking on the sanitary element.

According to the invention, this object is achieved by a sanitary element with the features of independent claim 1. Advantageous refinements of the sanitary element arise from dependent claims 2 to 14. The object is further achieved by a sanitary system according to claim 15. Advantageous embodiments of the sanitary system arise from the dependent claims 16 to 18. The object is also achieved by a method for controlling the sanitary system according to claim 19, and by the use of the sanitary system according to claim 20.

A sanitary element according to the invention according to a first aspect of the invention comprises a glass plate which is designed so as to transmit light at least partially, can be walked on and has a first surface formed on a first side of the glass plate and at least one illuminating element which is arranged on a side of the glass plate other than the first side, wherein an anti-slip arrangement is arranged or formed on the first surface of the glass plate, which anti-slip arrangement, when the sanitary element is installed, is configured to prevent slipping when the glass plate is walked on by a user, in particular during showering or bathing, and wherein a decorative layer is arranged between the at least one illuminating element and the glass plate.

The sanitary element is designed so as to be used in a sanitary system that is preferably integrated in a shower or bathtub or forms the shower or bathtub. The sanitary element can be a walk-on sanitary basin or any walk-on piece of furniture in the sanitary area.

Preferably, the sanitary element is designed as tile-like floor element in a shower or a bathtub and utilized as floor covering in wet cells.

Accordingly, the sanitary element is intended for use in a wet cell or a damp room. Damp rooms or wet rooms are rooms with high humidity, in particular due to water vapor. Damp rooms in the private sector are showers or bathtubs, for example. The floor or a tub in damp or wet rooms regularly comes into direct contact with running water. Wet rooms are also referred to as wet cells. The sanitary element is designed so as to be substantially waterproof, so that at least the respective illuminating element, preferably also the decorative layer and the sides of the glass plate other than the first side, are protected against moisture.

The sanitary element is provided for use in rooms with protection zone 0 according to DIN VDE 0100-701:2008-10. Protection zone 0 is defined as the interior of a bath tub or shower tray. For showers without trays, protection zone 0 is the wet floor area and the wall area up to a height of at least 5 cm above the floor covering.

The at least one illuminating element of the sanitary element is operated with a protection class of at least IPX5. Components with IPX5 certification are considered to be substantially water-resistant. Preferably, an IPX7 certification should be achieved. This means that the respective illuminating element is substantially sealed to the outside in a water-resistant manner. When reference is made to “the respective illuminating element” below, it shall be understood to mean “the at least one illuminating element”. The respective illuminating element is integrated in the sanitary element, wherein the sanitary element is permanently installed on the floor of the shower or the bathtub and can be walked on. When installed, only the first side with the first surface of the glass plate is visible to the user and can be walked on by the user. The other components of the sanitary element are not accessible when installed and are only partially visible, if at all.

The respective illuminating element is operated with an operating voltage of no more than 12 volts AC or no more than 30 volts DC. Due to the above classification, the transformer supplying the respective illuminating element with electrical current is located outside protection zone 0, so that the electrical supply lines are led out of the sanitary element to the transformer or direct to a voltage source. The low voltage makes the sanitary element very safe. It is conceivable that the sanitary element comprises several illuminating elements, each of which can be designed as LEDs or light-emitting diodes and/or as LED chains or LED networks.

The advantage of the decorative layer arranged between the illuminating element and the glass plate is that a subjectively positive shower or bath experience can be created for the users of the sanitary element when the illuminating element is switched on, wherein the decorative layer is illuminated by light rays of the respective illuminating element. A switched-on illuminating element lights up and shines through the decorative layer and the glass plate, so that the user can visually perceive the luminous glass plate with the image information displayed by the decorative layer. The image information can be displayed in high resolution so that different motifs, images and photos can be projected, which differs from the simple illuminating colors and designs of the prior art. In contrast, a switched-off illuminating element does not light up.

The decorative layer is designed in such a way, that light rays of the respective illuminating element are refracted when the illuminating element is switched on, and, looking at the first side of the glass plate, generate an optical effect that differs in perception from pure illumination of the glass plate without a decorative layer. For example, the decorative plate can be or comprise an image of an object, a person and/or a landscape, wherein the image shows the object, the person or the landscape from a specific camera perspective. The camera perspective can be, for example, a bird's eye view or a worm's eye view. The bird's eye view, for example by recordings of the object, the person or the landscape with the mentioned camera perspective, especially by using a camera drone, creates an impression for the viewer of being above the object, person or landscape displayed. In particular, a mountain, field, city, village or forest landscape can be shown from above. On the other hand, the worm's eye view, for example by recordings of the object, the person or the landscape with the mentioned camera perspective, creates the impression for the viewer of being below the object, person or landscape displayed. The decorative layer is preferably designed in such a way, that when light shines through it and through the glass plate that can be walked on on the first side of the glass plate, on which the user can stand or move while using the sanitary element, a section of the earth's surface with an essentially uniform structure and appearance can be seen. Such a decorative layer has a calming effect on the user of the sanitary element and thus increases their well-being.

The anti-slip arrangement of the sanitary element is arranged on the first surface of the glass plate or formed on the first surface in such a way, that, when the sanitary element is installed, a user cannot slip or slide away when walking on the sanitary element. In other words, the anti-slip arrangement increases slip resistance and improves foot safety, especially when the sanitary element is installed. The anti-slip arrangement enables the sanitary element to meet the requirements for classification in slip resistance class C and the slip resistance classes according to DIN 51097. The first surface of the glass plate is therefore an anti-slip surface. The anti-slip arrangement is in particular non-detachably connected to the glass plate, or an integral part of the glass plate. The anti-slip arrangement makes the first surface of the glass plate a non-slip surface and the user can safely enter or walk on the sanitary element.

The anti-slip arrangement can be arranged or formed completely on the first surface of the glass plate. Alternatively, the anti-slip arrangement is arranged or formed selectively or partially on the first surface of the glass plate, thus only on a certain area segment. In particular because of the anti-slip arrangement and the water-resistant design it is possible to use the sanitary element in protection zone 0, that is to say, in a shower or bathtub.

The sanitary element according to the invention is characterized by a simple and functionally reliable structure that can be installed without any special prior knowledge. Because the glass plate is designed so as to transmit light, the interior of a shower or bathtub in which the sanitary element is installed can be easily illuminated, preferably lit up. The sanitary element can be utilized in similar fashion in a bathtub, a whirlpool tub, in a shower or in a swimming pool.

In the context of this invention, “transmitting light” shall be understood to mean that the glass plate, as well as the decorative layer, is or are designed so as to be transmitting enough light or shining enough light through so that the user of the sanitary element on the first side of the glass plate can visually perceive the information to be displayed by the decorative layer through the glass plate. “Partially transmitting light” shall be understood to mean that the glass plate can also have areas that are not transmitting light or that are lightproof. Consequently, the glass plate can be embodied so as to be partially opaque in order to make elements of the sanitary element invisible, that are arranged under the glass plate and are otherwise visible for the user or to hide them under the glass plate, if any.

The glass plate is preferably designed so as to be transparent and/or translucent. In other words, the glass plate can be designed so as to be completely transparent or completely translucent. It is also conceivable that the glass plate is designed so as to be partially transparent and partially translucent. Therefore, in this case, the glass plate is transparent over a defined first portion of its total area and translucent over a defined second portion of its total area. The term “transparent” shall be understood to mean a light-transmitting and see-through design of the glass plate. The term “translucent” shall be understood to mean a design of the glass plate that is transmitting light, but nevertheless is opaque. Consequently, in this case, the glass plate has an at least partial shine-through design, wherein the decorative layer underneath or the content to be displayed with it is merely indicated or vaguely visible. The specific design of the glass plate with regard to its light transmittance allows the realizable optical effect of the decorative layer to be adapted to the user in a targeted manner. Hence, the decorative layer which, from the user's perspective, is arranged under the glass plate, in particular the content to be displayed with it, can be clearly visible or only vaguely visible.

The glass plate fulfills the well-known function of a plate-shaped tile or tile plate, wherein, when the sanitary element is installed, the first surface of the glass plate is arranged so as to be aligned with surfaces of neighboring tiles or first surfaces of glass plates of adjacent sanitary elements, so that the user is provided a flat surface for walking in the shower or bathtub. The glass plate is therefore preferably a plate-shaped, in particular rectangular, element that delimits the sanitary element towards the shower or bath area. The glass plate can be a tile plate formed from glass.

The glass plate is preferably a laminated safety glass plate. Laminated safety glass is a functional glass, representing a composite of at least two flat glass panes connected by a tear-resistant and visco-plastic film. The laminated safety glass plate is particularly impact-resistant and splinter-binding and has a high residual load-bearing capacity, even in the event of breakage.

The decorative layer preferably comprises a print layer. A decorative layer designed as a print layer is, for example, a printed plastic film, wherein the print layer is designed or formed to be transmitting light in such a way that the user can visually perceive the image or pattern displayed by the print layer when the illuminating element is switched on. The plastic film can be laminated onto an acrylic plate. Furthermore, the print layer can merely consist of an acrylic glass plate that has been printed directly. Consequently, the user is visually provided a same image or pattern by the decorative layer designed as a print layer.

Alternatively or additionally, the decorative layer comprises a digital image reproduction layer. The image reproduction layer can be designed to reproduce still images or moving images. Consequently, the image reproduction layer can be a still image reproduction layer and/or a moving image reproduction layer. The image reproduction layer shall be understood to be a digital panel which, as a type of screen, can display an image (still image reproduction layer), a series of images (still image reproduction layer) or a moving image (moving image reproduction layer). The information the image reproduction layer is made visually available to the user of the sanitary element when the illuminating element is switched on, with the digital image reproduction layer being illuminated by light rays from the respective illuminating element. The decorative layer can also be a combination of a print layer and a digital image reproduction layer, which combines the above-mentioned properties so that an individual optical effect can be achieved.

The print layer or the image reproduction layer is preferably glued to the glass plate. In other words, the print layer or the image reproduction layer is glued to a second surface of the glass plate. The print layer or the image reproduction layer is designed and glued to the glass plate in such a way that it/they can follow deformations of the sanitary element, in particular the glass plate. To make the adhesive or the adhesive layer invisible, the glass plate can be embodied all around the outer edge or where the adhesive is located, to be opaque, i.e. not transmitting light. The second surface of the glass plate is located preferably on a second side of the glass plate opposite to the first side of the glass plate. Furthermore, the first and second surfaces are preferably designed to be substantially parallel to one another.

Preferably, the anti-slip arrangement comprises a plurality of micro-troughs formed on the first surface or a ceramic coating applied to the first surface and having a plurality of elevations. The micro-troughs preferably have a diameter between 100 and 300 μm, preferably between 150 and 250 μm, particularly preferably of about 200 μm. At a diameter of the micro-troughs of between 100 and 300 μm optimal slip resistance can be implemented, without the user feeling uncomfortable walking on the glass plate.

The micro-troughs are provided to implement an anti-slip effect or to improve slip resistance. They can be formed as an organized or random dot grid on the first surface on the first side of the glass plate that can be walked on. The micro-troughs create a suction cup effect on the first surface. This effect is multiplied many times because of the plurality of micro-troughs and provides, for example, for a foot being slowed down steadily without stopping abruptly. Consequently, the slip resistance of the glass plate is increased, especially when water flows over the first surface of the glass plate or stands on the first surface while the sanitary element is being walked on. The more micro-troughs are formed on a certain area of the first side of the glass plate, the stronger the anti-slip effect.

The micro-troughs are preferably produced by means of a surface treatment process, for example by means of a diode laser. This means that the micro-troughs are formed, for example, as a lasered dot grid at least partially on the first surface of the glass plate. The advantage of the micro-troughs is also that the material of the glass plate is not changed in its transparency and hardness by the surface treatment. In addition, micro-troughs are abrasion-resistant, which means conversely no loss of effect over time.

The alternative ceramic coating is applied to the glass plate at least partially, preferably over the entire surface, using a suitable coating process. The ceramic coating has in particular a carrier material with a plurality of particles integrated into the carrier material, some of which protrude in the form of elevations from the carrier material of the ceramic coating in the direction of the interior of the shower or bathtub and thus prevent slipping or sliding when walking on the glass plate. The ceramic coating is designed so as to be transmitting light, so that, when looking at the sanitary element, in particular the glass plate, the visual effect of the respective illuminating element in combination with the decorative layer is visually perceptible without any interference.

The invention includes the technical teaching that the at least one illuminating element is embedded in an impact soundproofing layer or soundproofing layer or is arranged on a soundproofing layer. The respective illuminating element and the soundproofing layer thus form a coherent component, wherein the respective illuminating element having the soundproofing layer can be installed always in an exactly defined position relative to the glass plate. Accordingly, the electrical supply lines of the respective illuminating element can also be embedded in the soundproofing layer or attached to it. The soundproofing layer is preferably connected to the glass plate in a waterproof manner in order to protect the respective illuminating element from moisture.

According to one exemplary embodiment, the glass plate and the soundproofing layer are arranged so as to be enclosed by a frame element. The frame element is preferably formed in such a way, that it, together with the glass plate, spatially delimits the sanitary element. In others words, the sanitary element is spatially delimited on the one hand, that is to say on the first side of the glass plate, and, on the other hand, by the frame element. This makes the sanitary element easier to transport, store and install. The frame element can be made of sheet metal. Sheet metal is a metallic rolled product whose width and length are very much greater than its thickness. The sheet metal can be formed by suitable forming steps, for example by deep drawing, to form a frame element.

The frame element is preferably designed in the form of a basin or a cup. This allows the sanitary element to be additionally sealed. The components of the sanitary element, that is to say the glass plate in particular, the decorative layer, the respective illuminating element and, if any, other components, are therefore inserted into the basin- or cup-shaped frame element and, if necessary, attached to it and sealed. Accordingly, the frame element protects the interior of the sanitary element from unwanted ingress of moisture. If the frame element is designed in the form of a basin or a cup, it has at least one, preferably exactly one opening through which the electrical supply lines are led out of the sanitary element for connection to a voltage source and/or a transformer. To this end, the opening preferably has sealant for sealing the interior of the sanitary element from the outside atmosphere. Such a seal is at least a liquid proof seal.

The invention includes the technical teaching that sound insulation and/or a sealing fleece are/is arranged on an outside of the frame element. Preferably, the sealing fleece and the sound insulation are interconnected. The sound insulation improves the impact sound insulation of the sanitary element in particular. The sealing fleece improves the protection against unintentional liquid ingress into the interior of the sanitary element. The sound insulation and/or the sealing fleece are arranged at least partially around the frame element, preferably all the way around the frame element. The sound insulation is designed, for example, in the form of a sound insulation strip or tape. The sealing fleece is designed, for example, in the form of a sealing fleece strip or tape. The sealing fleece can be attached directly to the frame element or to the sound insulation using adhesives, for example. The sound insulation can be attached directly to the frame element or to the sealing fleece using adhesives, for example.

Alternatively or additionally, a sealant is arranged between the frame element and the glass plate and/or, if present, between the frame element and the sound insulation layer. If a soundproofing layer is present, the sealant can also be partially arranged between the glass plate and the soundproofing layer. The sealant can be poured into the remaining gaps after the glass plate and the respective illuminating element have been assembled and/or to the frame element, so that an integrated component of the sanitary element remains after the sealant has hardened. Alternatively, the sealant can also be arranged in the form of a fleece or the like at the locations mentioned or between the components mentioned.

According to one exemplary embodiment, the sanitary element further comprises a drainage module that is at least indirectly connected to the glass plate. The drainage module is integrated into the sanitary element, so that a coherent component can be implemented that can already be assembled at the factory in such a way that the sanitary element is formed to be leakproof. This in turn simplifies the assembly of the sanitary element. This means that the drainage module is preferably arranged in a sealing manner on the glass plate. The term “arranged in a sealing manner” shall be understood to mean that the drainage module is arranged on or attached to the glass plate in such a way that there is no ingress of moisture between the drainage module and the glass plate into the interior of the sanitary element. A drainage module comprises in particular a drainage channel, which can be arranged on a side edge of the sanitary element, in particular the glass plate. Alternatively, the glass plate can have a recess to accommodate the drainage module, in particular a drainage channel, a drainage pipe or the like. The drainage module can thus penetrate the sanitary element starting from the first surface of the glass plate, that is to say starting from the top of the sanitary element that comes into contact with the user, downwards in the direction of a drainage. Accordingly, the components arranged under the glass plate, in particular the respective illuminating element and, if any, the soundproofing layer and/or the frame element, are also provided with a recess through which the drainage module runs. A liquid present on the first surface can be discharged or drained downwards to an outlet via the drainage module. In addition, the drainage module can have piping designed to connect a drainage channel or a drainage pipe of the drainage module with an outlet or a sewage system. Consequently, the drainage module is designed to be connected to an outlet or sewage system.

Preferably, the at least one illuminating element comprises an acrylic glass plate (or also referred to as acrylic glass, acrylic plate, synthetic glass or acrylic glass plate) arranged on the side of the glass plate other than the surface that can be walked on, which can be illuminated on at least one end face by at least one illuminant. The at least one illuminant can be or comprise at least one LED, one LED chain, one LED tape or one LED strip. According to one exemplary embodiment, the illuminant in the form of an LED strip is glued to or arranged on at least one, preferably several, more preferably all end faces of the acrylic glass plate. Consequently, the acrylic glass plate is illuminated from the side, wherein the acrylic glass plate is designed in such a way that the light is diffusely scattered, so that the acrylic glass plate shines in the direction of the decorative layer. This means that the respective illuminant is arranged on at least one side of the acrylic glass plate whose surface is arranged substantially perpendicular to the first and/or second side of the glass plate.

The acrylic glass plate is arranged on a second side of the glass plate opposite to the first side, in particular glued to it. If several illuminants are provided, these can be interconnected via connecting lines, wherein at least one connection cable for the illuminants is led to the outside, in particular downwards, out of the sanitary element. Consequently, the connecting line is led out on a side of the sanitary element on which the glass plate is not located.

Furthermore, the sanitary element preferably comprises a transceiver unit connected at least to the at least one illuminating element and designed to communicate with an external input unit in order to at least change the illuminating properties of the at least one illuminating element. The transceiver unit is part of the sanitary element or is integrated in it. The illuminating properties of the respective illuminating element can be adapted to the wishes of the user by means of the transceiver unit, wherein the transceiver unit can be controlled by the user via the external input unit.

The respective illuminating element has a plurality of different illuminating properties that can be set by the transceiver unit. Illuminating properties shall be understood to mean in particular properties of the respective illuminating elements that are visually perceptible by the user of the sanitary element and which change the optical effect of the luminous glass plate. Setting illuminating properties consists, for example, in switching the respective illuminating element on and off. Furthermore, the setting of illuminating properties can comprise changing a light color, a color reproduction, a light intensity, a light flux, a light quantity, a luminance and/or a still or moving image content.

A sanitary system according to the invention according to a second aspect of the invention comprises at least one sanitary element according to the first aspect of the invention and the external input unit. The external input unit is preferably a smartphone and/or a touch screen and/or an input module comprising an input key. The sanitary system is in particular designed as a shower or bathtub or functionally integrated in a shower or bathtub. The sanitary system can comprise several sanitary elements according to the first aspect of the invention, in which case the transceiver units of the several sanitary elements can be interconnected. Alternatively, a single transceiver unit can be provided which is connected to all sanitary elements for control purposes in order to be able to control the illuminating properties of individual, several or all illuminating elements.

The external input unit can be wired or wirelessly connected, for example via Bluetooth or WiFi/WLAN, to the transceiver unit. This allows a simple and intuitive setting of the illuminating properties of the respective illuminating element, in particular the respective illuminant of the illuminating element. The transceiver unit is preferably further connected with the decorative layer, provided the latter is designed as a digital image reproduction layer. Accordingly, the external input unit and the transceiver unit are additionally designed in such a way that the information displayed with the decorative layer can be actively influenced by appropriate control.

A wired external input unit is, for example, an input module comprising a touchscreen and/or an input key. Such an input unit can be located, for example, in the shower cubicle or in immediate vicinity of the bathtub from where it can be manually operated by the user of the sanitary system to generate input commands which are transmitted as switching signals from the input unit to the transceiver unit.

Alternatively, the input unit can be a smartphone or the like, wherein input commands can be generated via a corresponding application stored on the smartphone, which are transmitted as switching signals from the smartphone at least indirectly to the transceiver unit. In this context, “at least indirectly” means that the input commands input into the application can be transmitted directly, in particular by means of one WiFi/WLAN or Bluetooth connection, or indirectly, in particular via a cloud application or an Internet application, as switching signals to the transceiver unit. The transceiver unit can therefore comprise a WiFi/WLAN module and/or a Bluetooth module. In a cloud or Internet application, a plurality of different input commands, which are linked to at least certain illuminating properties of the respective illuminating element, can be stored in an online database from which the user can select one or more desired input commands which, after selection, are transmitted as corresponding switching signal at least for setting the illuminating properties of the respective illuminating element, in particular the illuminant, to the transceiver unit.

In a refinement of the invention, the sanitary system further comprises an audio unit and/or a scenting unit, wherein the external input unit is designed to communicate with the audio unit or the scenting unit. With such a sanitary system, a complete multi-sensory product can be provided that combines all human senses (sight, touch, sound, taste, smell) to create an complete shower or bathing experience. The audio unit or the scenting unit can be used to add more content, in particular sound content that particularly appeals to the user's hearing and/or scents that particularly appeal to the user's smell and taste, to the image content provided by the decorative layer when the illuminating element is switched on, which particularly addresses the user's sight.

The audio unit can be or comprise a sound source, such as, for example, a Bluetooth or similar, wireless jukebox or music unit that reproduces atmospheric sound and/or noise content. The audio unit shall also be understood to be an audio output device or an audio playback unit. The scenting unit can be or comprise a scent organ or the like, which is configured to scent the space within the bathing or shower cubicle according to the individual design of the image content visually displayed by means of the decorative layer. The scenting unit shall be understood as a scent medium dispensing device or as a scent dispensing unit.

According to this refinement, the audio unit and/or the scenting unit can each have a separate transceiver unit, each of which is configured to communicate with the transceiver unit of the sanitary element. The input unit can be connected to the transceiver unit mentioned above in the manner described above. Alternatively, the audio unit and/or the scenting unit can be designed so as to be directly controllable by the transceiver unit of the sanitary element.

The input unit can be used to transmit switching signals to the transceiver unit, which, in addition to the illuminating properties des respective illuminating element, can also customize audio content and/or scents.

In one embodiment of the sanitary element, said sanitary element comprises a cooling element arranged in thermal contact with the illuminating element on a side of the illuminating element opposite to the glass plate. The thermal contact serves to transfer heath from the illuminating element into the cooling element and thus cool the illuminating element. Cooling the illuminant prevents or reduces thermally induced aging of the illuminating element and/or other thermally sensitive components in the sanitary element. The heat transferred to the cooling element can be dissipated from the cooling element in various ways. This can be done, for example, by cooling the cooling element by means of a coolant or by heat radiation at the side of the cooling element facing away from the illuminant. Here, the cooling element can be in direct mechanical contact with the illuminating element. Alternatively, an intermediate layer made of a good heat-dissipating material can be arranged between the cooling element and the illuminating element, for example, to promote adhesion between the cooling element and the illuminating element, such as a thermally conductive adhesive layer. This intermediate layer can also compensate for surface irregularities between the elements.

Here, the cooling element can cover at least half of the side of the illuminating element opposite to the glass plate. This can already achieve a significant cooling effect of the illuminating element. A better cooling effect is achieved if the cooling element covers more than 90% of the side of the illuminating element opposite to the glass plate, preferably the coolant completely covers the side opposite to the glass plate. In this case, all areas of the illuminating element can be cooled directly.

In a further embodiment, the cooling element comprises a thermal conductor in which one or more cooling coils are embedded for carrying a coolant. By means of the coolant, on the one hand, the thermal conductor of the cooling element can be brought to a constant, controllable temperature and heat transferred from the illuminating element can be easily and reliably dissipated. The cooling coils can be made of copper, for example. The thermal conductor can consist of aluminum or another material or alloy, for example. For example, the cooling element has a thickness of 12 mm in the direction of the illuminating element. Depending on the desired cooling performance, one or more, for example two or three, separate cooling coils can be arranged in the thermal conductor. Several cooling coils have a larger throughput of coolant than just a single cooling coil. The coolant can be water or another suitable coolant.

In a further embodiment, the one or more cooling coils comprise an inlet and an outlet for the coolant per cooling coil. The cooling coils can thus be connected directly to the coolant supply, for example to the cold water supply in the sanitary area or another cold water supply. The inlets and outlets of the cooling coil(s) can be arranged on only one side of the sanitary element in order to simplify the design of the connections to the coolant supply.

In a further embodiment, the sanitary element comprises an enclosure which encloses at least the illuminating element and the cooling element. This way, a compact component is provided that is easy to install and put into operation. Here, the enclosure can be connected to the glass plate for rear encapsulation of the sanitary element. The contact point between the enclosure and the glass plate can be configured differently depending on the embodiment, for example with ribs arranged underneath the glass plate that point radially away from the illuminant. Such ribs can be 60 mm in length. The enclosure can be made of 2.5 mm thick stainless steel, for example, preferably with a U-shape (stainless steel tray) that encloses the other components of the sanitary element and ends with the glass plate on the walk-on side. The glass plate can be made of 8 mm thick LSG material.

In a third aspect of the invention, a method according to the invention for controlling the sanitary system, preferably according to the second aspect of the invention, comprises the following steps: generating switching signals depending on input commands input with the external input unit; and transmitting the switching signals from the external input unit to the transceiver unit; and controlling the illuminating properties of at least the at least one illuminating element by the transceiver unit depending on the received switching signals.

Therefore, a method is provided that aims to go beyond the element of “light” in order to merge all other senses of a bathing or showering person in a single complete shower and/or bathing experience. Consequently, the user will have a coherent overall sensual experience. The sanitary system according to the invention creates a so-called “Multi-Sensory Shower” or a so-called “Multi-Sensory Bath”. The sanitary system according to the invention can be used advantageously as “vitamin D shower” or “vitamin D bath”. In addition, the sanitary system increases the well-being of the user, in particular the increase or elevation of melatonin, serotonin and vitamin D. The sanitary system is embedded in a complete multisensory sanitation experience. Consequently, the sanitary system opens up a complete multisensory sanitation experience.

The sanitary system according to the second aspect of the invention is particularly suitable for use in a shower or in a bathtub. Thus, the sanitary system can be a shower or be integrated in a shower. Alternatively, the sanitary system can be a bathtub or be integrated in a bathtub.

The above definitions as well as explanations of technical effects, advantages and advantageous embodiments of the sanitary element according to the invention apply analogously also for the sanitary system according to the invention according to the second aspect of the invention and for the method according to the invention according to the third aspect of the invention, and vice versa. It shall be understood that the features mentioned above and those to be explained below can be used not only in the combination specified in each case, but also in other combinations or on their own, without departing from the scope of the present invention.

### BRIEF DESCRIPTION OF THE DRAWING

Further advantages, special features and expedient refinements of the invention will become apparent from the dependent claims and the following presentation of preferred exemplary embodiments with reference to the figures of the drawing.

FIG. 1: shows a qualitative cross-section of a sanitary element according to the invention.

FIG. 2: shows one qualitative perspective view on sanitary element according to the invention.

FIG. 3: shows a schematic representation of a sanitary system according to the invention.

FIG. 4: shows a block diagram of a method according to the invention.

FIG. 5: shows a block diagram of an embodiment of the method according to the invention.

FIG. 6: shows an embodiment of the sanitary element according to the invention having a cooling element.

FIG. 7: shows two different embodiments of the cooling element.

### DETAILED DESCRIPTION

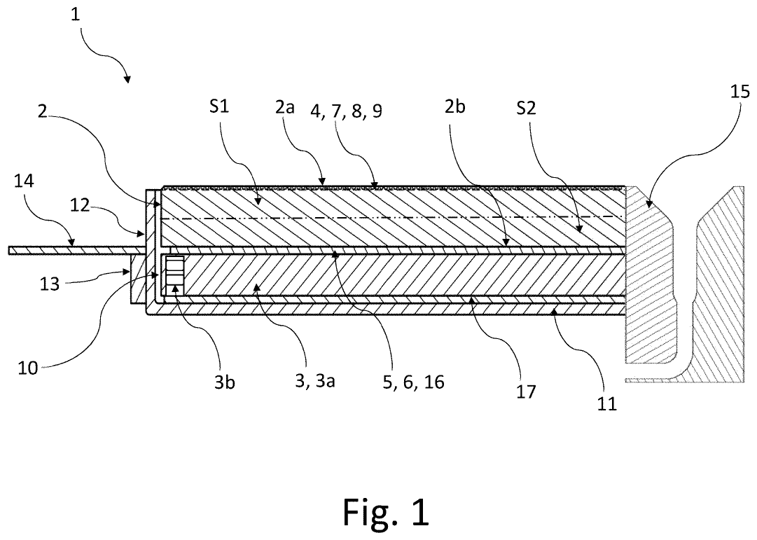

FIG. 1 shows a qualitative cross-section of a sanitary element 1 according to the invention. Sanitary element 1 can be utilized as a floor element in showers or bathtubs, where it can be installed, for example, next to floor tiles or floor plates in the floor of the shower or tub.

Sanitary element 1 comprises a glass plate 2 which is designed so as to transmit light at least partially, can be walked on and is received in a frame element 11, here made of aluminum. Glass plate 2 has a first surface 2a on a first side S1 of glass plate 2, where a user can walk on glass plate 2. Inside sanitary element 1, that is to say on a side S2 of glass plate 2 other than side S1, an illuminating element 3 is arranged comprising an acrylic glass plate 3a as well as an illuminant 3b. In the present case, first and second sides S1, S2 are located at opposite sides of glass plate 2

An anti-slip arrangement 4 is arranged or formed at first surface 2a of glass plate 2, which, when sanitary element 1 is installed, is configured to prevent slipping when a user walks on glass plate 2, especially while showering or bathing. According to FIG. 1, anti-slip arrangement 4 comprises a plurality of micro-troughs 7 formed on first surface 2a. Micro-troughs 7 have a diameter between 100 μm and 300 μm, particularly preferably between 100 μm and 200 μm or 200 μm-300 μm. Instead of micro-troughs 7 formed on first surface 2a, anti-slip arrangement 4 can also comprise a ceramic coating 8 applied to first surface 2a applied with a plurality of elevations 9.

A decorative layer 16 is arranged between illuminating element 3 and glass plate 2. The decorative layer 16 can comprise or be a print layer 5 and/or a digital image reproduction layer 6. In the present case, decorative layer 16 is glued to a second surface 2b of glass plate 2. Print layer 5 or image reproduction layer 6 can be glued to glass plate 3. Glass plate 2 is a laminated safety glass plate, made of at least two flat glass panes with a tear-resistant and visco-plastic film arranged between them (shown in dash-dotted lines in glass plate 2). In the present case, glass plate 2 is designed so as to be transparent, so that the user upon entering sanitary element 1 and when illuminating element 3 is switched on, can view decorative layer 16 through glass plate 2. Decorative layer 16 is arranged in the layer-by-layer-based structure of sanitary element 1 between glass plate 2 and acrylic glass plate 3a of illuminating element 3. Illuminant 3b is arranged on an end face of acrylic glass plate 3a and causes acrylic glass plate 3a to light up when switched on.

Illuminating element 3 together with decorative layer 16 are enclosed and surrounded by frame element 11, wherein illuminating element 3 is embedded in a sealant 10 which fills the gaps between frame element 11, decorative layer 16, illuminating element 3 and glass plate 2. Acrylic glass plate 3a is arranged on a (n) (impact) soundproofing layer 17 with its bottom, which in the present case is not arranged on sealant 10. Soundproofing layer 17 serves to cushion the load, either completely or partially, by a user, thereby increasing the service life of sanitary element 1. Sealant 10 serves as a seal or as a buffer between frame element 11 and the arrangement of glass plate 2, decorative layer 5, 6, 16, illuminating element 3 and (impact) soundproofing layer 17, on the one hand to seal against moisture and on the other hand to compensate material properties as a flexible buffer in the event of thermal stress.

In addition, a sound insulation 13 and/or a sealing fleece 14 is arranged on an outside 12 of frame element 11, wherein, in the present case, sealing fleece 14 and sound insulation 13 are interconnected. Sound insulation 13 improves the impact sound insulation of sanitary element 1 also by absorbing the sound between sanitary element 1 and elements or components adjacent to sanitary element 1. Sealing fleece 14 improves protection against liquids accidentally ingressing into the interior of sanitary element 1.

According to FIG. 1, sanitary element 1 according to the invention further comprises a drainage module 15, which is at least indirectly connected to glass plate 2. This allows easier installation of sanitary element 1 in the shower or bathtub.

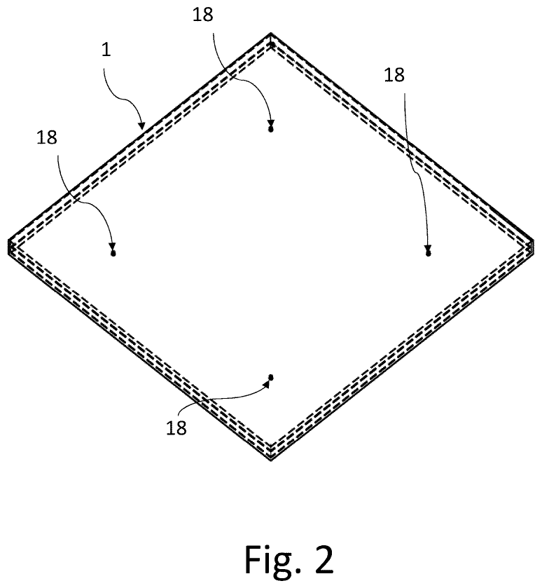

FIG. 2 shows a qualitative perspective view of a sanitary element 1 according to the invention according to FIG. 1, wherein sanitary element 1 represents the different layers (dashed lines) from the description of FIG. 1. In addition, FIG. 2 shows vent holes 18, which are important for the manufacturing process to prevent air inclusion after compression of the layers by allowing the air to escape out of ventilation holes 18. The ventilation holes are located in frame element 11, which, by depiction of the transparent or translucent layers, can function as if they were also present in other layers. The number and size of ventilation holes 18 are variable in this case. In the present case, sanitary element 1 has four ventilation holes 18.

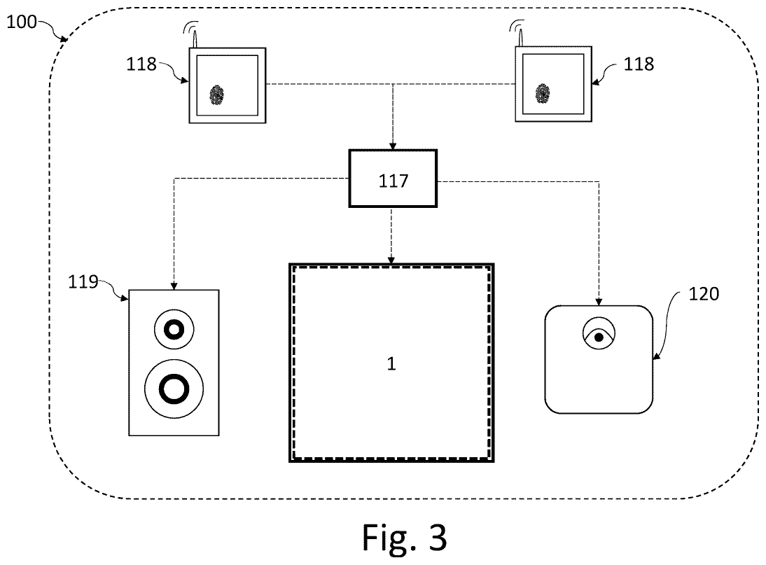

FIG. 3 shows a schematic representation of a sanitary system 100 according to the invention, which comprises a sanitary element 1 according to FIG. 1 or 2. Sanitary element 1 further comprises a transceiver unit 117 connected at least to the at least one illuminating element 3, which can also be understood as a conventional control unit and is designed to communicate with several external input units 118 in order to change the illuminating properties of the at least one illuminating element 3. Sanitary system 100 is in particular a shower or a bathtub and, in the present case, comprises two external input units 118. Respective external input unit 118 can be a smartphone and/or a touchscreen and/or an input module comprising an input key. The user can use any one of input units 118 to arbitrarily set the illumination and/or images in sanitary element 1. The type and the extent of the setting options depends on the design of illuminating element 3 and the formation of decorative layer 16. In particular, if decorative layer 16 is designed as an image reproduction layer, can image- or video content of decorative layer 16 can be adapted to the wishes of the user to positively impact their subjective showering or bathing experience.

According to FIG. 3, sanitary system 100 further comprises an audio unit 119 and a scenting unit 120. Input units 118 are further designed to communicate with audio unit 119 or scenting unit 120 via transceiver unit 117.

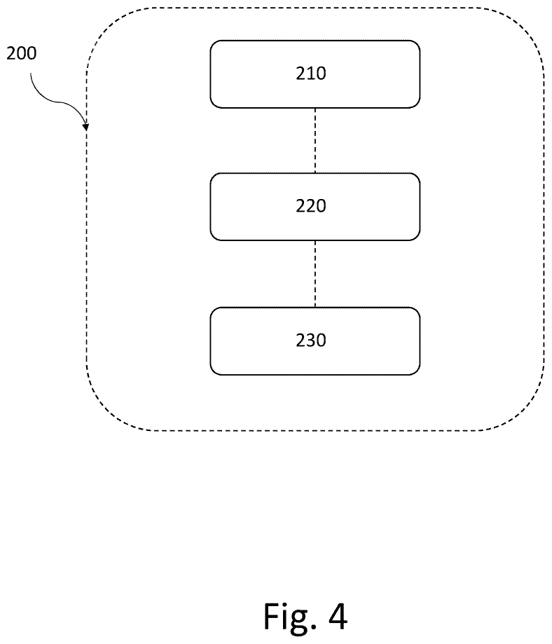

FIG. 4 shows a block diagram of a method 200 according to the invention for controlling sanitary system 100 according to FIG. 3, comprising the steps
generating 210 switching signals depending on input commands input with one or more of external input units 118;
transmitting 220 the switching signals from the respective external input unit 118 to transceiver unit 117;
controlling 230 the illuminating properties of at least the at least one illuminating element 3 by transceiver unit 117 depending on the received switching signals. Further steps may consist of controlling audio unit 119 and/or scenting unit 120 depending on the generated switching signals according to generating 210.

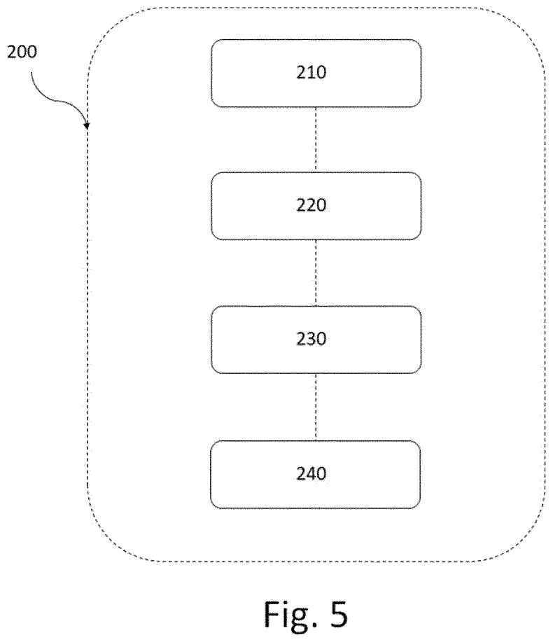

FIG. 5 shows a block diagram of an embodiment of method 200 according to the invention, which, as compared to the method shown in FIG. 4, additionally comprises the step of cooling 240 illuminating element 3 with a cooling element 19 being in contact with the illuminating element 3.

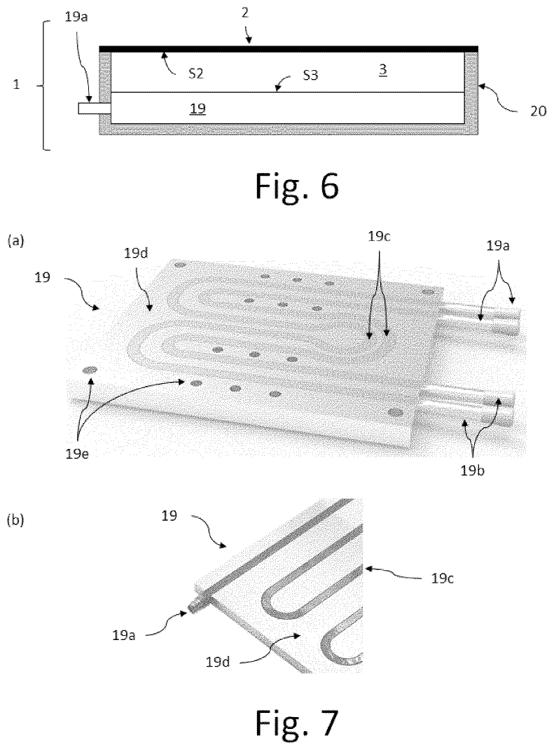

FIG. 6 shows an embodiment of sanitary element 1 according to the invention having a cooling element 19, which is arranged in thermal contact with illuminating element 3 on a side S3 of the illuminating element 3 opposite to glass plate 2. The embodiment in FIG. 6 can also comprise all components according to FIG. 1, even if they are not shown explicitly here. In this embodiment, cooling element 19 completely covers side S3 of illuminating element 3 opposite to glass plate 2. In other embodiments there can also be only partial coverage. Coolant can actively flow through cooling element 19 via an inlet 19a and an outlet 19b (not shown here) or can also passively dissipate any absorbed heat by radiation. The configuration and routing of the active cooling can be configured differently depending on the embodiment of cooling element 19. Sanitary element 1 additionally comprises an enclosure 20 enclosing illuminating element 3 and cooling element 19. Here, enclosure 20 is connected to glass plate 2 for the rear encapsulation of the sanitary element. Due to the cooling, digital image reproduction layers 6 with a long service life can be used (see FIG. 1), for example 500×500 mm LED panels of 60 mm thickness.

FIG. 7 shows two different embodiments of cooling element 19. In FIG. 7 (a), cooling element 19 comprises two separate cooling coils with respective inlets and outlets 19a, b for the coolant, wherein the cooling coils are embedded in a thermal conductor 19d. Two cooling coils 19c are meandering here parallel to each other through thermal conductor 19d. In FIG. 7 (b), merely a single cooling coil is embedded in thermal conductor 19d. Only inlet 19a is shown here. Outlet 19b is not shown here and is located outside the detail image of FIG. 7 (b). The shape of the routing of cooling coil 19c is configured similarly to that in FIG. 7 (a).

The embodiments shown here only represent examples of the present invention and shall therefore not be understood as quantitative or limiting. Alternative embodiments considered by those skilled in the art are equally encompassed within the scope of the present invention.

List of reference numerals:

| | |
|---|---|
| 1 | sanitary element |
| 2 | glass plate |
| 2a | first surface of the glass plate |
| 2b | second surface of the glass plate |
| S1 | first side of the glass plate |
| S2 | second side of the glass plate |
| 3 | illuminating element |
| 3a | acrylic glass plate |
| 3b | illuminant (LED) |
| 4 | anti-slip arrangement |
| 5 | print layer |
| 6 | image reproduction layer |
| 7 | micro-trough |
| 8 | ceramic coating |
| 9 | elevation of the ceramic coating |
| 10 | sealant |
| 11 | frame element |
| 12 | outside of the frame element |
| 13 | sound insulation |
| 14 | sealing fleece |
| 15 | drainage module |
| 16 | decorative layer |
| 17 | (impact) soundproofing layer |
| 18 | vent hole |
| 19 | cooling element |
| 19a, 19b | connection for coolant |
| 19c | cooling coil |
| 19d | thermal conductor |
| 19th | installation holes or ventilation holes |
| 20 | enclosure |
| 100 | sanitary system |
| 117 | transceiver unit |
| 118 | input unit |
| 119 | audio unit |
| 120 | scenting unit |
| 200 | method for controlling a sanitary system |
| 210 | generating switching signals depending on input commands |
| | input with the external input unit |
| 220 | transmitting the switching signals from the external input |
| | unit to the transceiver unit |
| 230 | controlling the illuminating properties at least of at least |
| | the one illuminating element by the transceiver unit depending |
| | on the received switching signals |
| 240 | cooling the illuminating element with a cooling element in |
| | contact with the illuminating element |

1. A sanitary element, comprising a glass plate which is designed so as to transmit light at least partially, can be walked on and has a first surface formed on a first side of the glass plate and at least one illuminating element which is arranged on a side of the glass plate other than the first side, wherein an anti-slip arrangement is arranged or formed on the first surface of the glass plate, which anti-slip arrangement, when the sanitary element is installed, is configured to prevent slipping when the glass plate is walked on by a user, and wherein a decorative layer is arranged between the at least one illuminating element and the glass plate.

2. The sanitary element according to claim 1,
wherein the decorative layer comprises a print layer and/or a digital image reproduction layer.

3. The sanitary element according to claim 2,
wherein the print layer or the image reproduction layer is glued on the glass plate.

4. The sanitary element according to claim 1,
wherein the anti-slip arrangement comprises a plurality of micro-troughs formed on the first surface, or a ceramic coating applied on the first surface and having a plurality of elevations.

5. The sanitary element according to claim 4,
wherein the micro-troughs have a diameter between 100 and 300 μm.

6. The sanitary element according to claim 1,
wherein the glass plate is designed so as to be completely transparent or completely translucent.

7. The sanitary element according to claim 1,
wherein at least one part of the at least one illuminating element is embedded in a sealant or arranged at a sealant.

8. The sanitary element according to claim 7,
wherein the other part of the illuminant is arranged on a soundproofing layer.

9. The sanitary element according to claim 7,
wherein the glass plate and the sealant are arranged so as to be enclosed by a frame element.

10. The sanitary element according to claim 9,
wherein sound insulation and/or a sealing fleece are/is arranged on an outside of the frame element.

11. The sanitary element according to claim 10,
wherein the sealing fleece and the sound insulation are interconnected.

12. The sanitary element according to claim 1,
further comprising a drainage module, which is at least indirectly connected to the glass plate.

13. The sanitary element according to claim 1,
wherein the at least one illuminating element comprises an acrylic glass plate arranged on the side of the glass plate other than the walkable surface and which, on at least one end face, can be illuminated by at least one illuminant.

14. The sanitary element according to claim 1,
further comprising a transceiver unit connected at least to the at least one illuminating element and designed to communicate with an external input unit in order to change at least the illuminating properties of the at least one illuminating element.

15. The sanitary element according to claim 1,
further comprising a cooling element arranged in thermal contact with the illuminating element on a side of the illuminating element opposite to the glass plate.

16. The sanitary element according to claim 15,
wherein the cooling element covers the opposite side of the illuminating element at least half, preferably more than 90%, particularly preferably completely.

17. The sanitary element according to claim 15,
wherein the cooling element comprises a thermal conductor in which one or more cooling coils are embedded for carrying a coolant.

18. The sanitary element according to claim 17,
wherein the one or more cooling coils comprise one inlet and one outlet for the coolant per cooling coil.

19. The sanitary element according to claim 15,
further comprising an enclosure enclosing at least the illuminating element and the cooling element, the enclosure preferably being connected to the glass plate for rear encapsulation of the sanitary element.

20. A sanitary system, comprising at least one sanitary element according to claim 1, and an external input unit.

21. The sanitary system according to claim 20,
wherein the external input unit is a smartphone or a touchscreen or an input module comprising an input key.

22. The sanitary system according to claim 20,
further comprising an audio unit and/or a scenting unit, wherein the input unit is designed to communicate with the audio unit or the scenting unit.

23. The sanitary system according to claim 20,
wherein the sanitary system is designed as a shower or bathtub.

24. A method for controlling a sanitary system, comprising at least one sanitary element according to claim 1, and an external input unit comprising a smartphone or a touchscreen or an input module comprising an input key, wherein the sanitary system further comprises an audio unit and/or a scenting unit, wherein the external input unit is designed to communicate with the audio unit or the scenting unit, and wherein the sanitary system is designed as a shower or bathtub, comprising the steps:
generating switching signals depending on input commands input with the external input unit; and
transmitting the switching signals from the external input unit to the transceiver unit;
controlling the illuminating properties of at least the at least one illuminating element by the transceiver unit depending on the received switching signals.

25. The method according to 24, further comprising the step of cooling the illuminating element with a cooling element being in contact with the illuminating element.

26. Use A method of using a sanitary system comprising at least one sanitary element according to claim 1, and an external input unit comprising a smartphone or a touchscreen or an input module comprising an input key, wherein the sanitary system further comprises an audio unit and/or a scenting unit, wherein the external input unit is designed to communicate with the audio unit or the scenting unit, and wherein the sanitary system is designed as a shower or bathtub, comprising the step of providing the sanitary system in a shower or a bathtub.
